(19) United States
(12) Patent Application Publication
(10) Pub. No.: US 2005/0200887 A1
(43) Pub. Date: Sep. 15, 2005

(54) Direct printing machine, direct printing method and computer-readable recording medium storing direct printing program

(76) Inventor: Xuqiang Bai, Ibaraki-ken (JP)

Correspondence Address: NATH & ASSOCIATES, PLLC, Sixth Floor, 1030 15th Street, N.W., Washington, DC, 20005, US

(21) Appl. No.: 11/072,245

(22) Filed: Mar. 7, 2005

(30) Foreign Application Priority Data
Mar. 10, 2004 (JP) P2004-067596

(51) Int. Cl. G06F 15/00

(52) U.S. Cl. 358/1.15

(57) ABSTRACT

A direct printing unit 35 acquires document formats of document file names read in accordance with information regarding a printing order, which is stored in an output control data storage unit 41, and activates document file expansion programs corresponding to the acquired document formats with reference to an activation program table stored in advance in an output method storage unit 23. The direct printing control unit 35 acquires printing intermediate files of document files corresponding to document file names, which are outputted from the activated document file expansion programs, and stores the acquired printing intermediate files in an output data storage unit 24. Then, an output data editing unit 36 edits the acquired printing intermediate files in accordance with an output format set by a user with reference to an output format storage unit 42.

### BACKGROUND OF THE INVENTION

1. Field of the Invention

The present invention relates to a direct printing machine, a direct printing method and a computer-readable recording medium storing a direct printing program for making layout for plural document files different in document format and printing and outputting the document files according to an output format designated by a user.

2. Description of the Related Art

Heretofore, as a first method for printing plural document files, a method has been known, in which the plural document files to be printed are expanded in a lump by using an application program capable of expanding plural document files different in document format in a lump, and the plural document files expanded in a lump are subjected to layout and printed according to a designated output format. Moreover, as a second method for printing the plural document files, a method as disclosed in Japanese Patent Laid-Open Publication No. Hei 9-185605 (published in 1997) has been known, in which the plural document files to be printed are sequentially expanded and printed.

However, in accordance with the first method, the plural document files cannot be printed if the application program capable of expanding the plural document files different in document format in a lump does not exist. Note that, for example, like those of Word (registered trademark), Excel (registered trademark), Ichitaro (registered trademark) and the like, a large number of document formats for the document files exist, and in addition, many software developing companies do not disclose details of the document formats thereof. Accordingly, in fact, it is impossible to create such an application program capable of expanding the plural document files different in document format in a lump. Moreover, even if the application program as described above is created, in the case of coupling-printing processing in which the document files different in document format are printed collectively on designated print sheets, it is necessary for the application program to expand in a lump all the document files to be printed, which requires enormous processing time and system resource.

Meanwhile, in accordance with the second method, it is not necessary to expand in a lump all the document files to be printed, and it is also possible to designate a printing order of the document files. However, the document files cannot be printed according to a desired uniform output format, and in addition, the plural document files different in document format cannot be simultaneously subjected to the layout to be printed and outputted according to the designated output format.

### SUMMARY OF THE INVENTION

In order to solve the problems as described above in the case of printing the plural document files different in document format, it is an object of the present invention to provide a direct printing machine, a direct printing method and a computer-readable recording medium storing a direct printing program, which are capable of making the layout for the plural document files different in document format and printing and outputting the document files concerned according to the designated output format with a saved resource and in a short time even in the case where the plural document files concerned are instructed to be printed in a lump.

In order to solve the above-described problems, a direct printing machine in the present invention includes: an output control data setting unit which acquires, with regard to plural document files, information regarding document file names and the number of document files as output control data upon receiving an instruction to print the plural document files; an output control data storage unit which stores the output control data acquired by the output control data setting unit; an output method storage unit which stores an activation program table describing activation programs for activating document file expansion programs capable of expanding the document files depending on document formats of the document files; an output format setting unit which sets an output format for printing intermediate files outputted by the document file expansion programs activated by the activation programs; an output format storage unit which stores the output format which is set by the output format setting unit; a direct printing control unit which sequentially selects document file names to acquire document formats thereof with reference to the output control data stored by the output control data storage unit, activates document file expansion programs corresponding to the acquired document formats with reference to the activation program table stored in the output method storage unit, and acquires printing intermediate files of document files corresponding to document file names outputted from the activated document file expansion programs; an output data storage unit which stores the printing intermediate files of the document files, the printing intermediate files being acquired by the direct printing control unit; an output data editing unit which edits the printing intermediate files of the document files, the printing intermediate files being stored in the output data storage unit, in accordance with the output format for the printing intermediate files, the output format being stored in the output format storage unit; an output unit which transmits, to a printing unit, the printing intermediate files of the document files, the printing intermediate files being edited by the output data editing unit; and the printing unit which prints and outputs the document files in accordance with the printing intermediate files edited by the output data editing unit and transmitted from the output unit.

Moreover, a direct printing method in the present invention includes the steps of: acquiring and storing, with regard to plural document files, information regarding document file names and the number of document files as output control data upon receiving an instruction to print the plural document files from a user; sequentially selecting document file names to acquire document formats thereof with reference to the output control data; storing an output format for printing intermediate files outputted by document file expansion programs for expanding the document files, the output format being set by the user; activating document file expansion programs corresponding to the acquired document formats with reference to an activation program table describing activation programs for activating the document file expansion programs capable of expanding the document files depending on the document formats of the document files, and acquiring and storing printing intermediate files of document files corresponding to document file names outputted from the activated document file expansion programs; editing the stored printing intermediate files of the document files in accordance with the output format which is set by the user; and transmitting the edited printing intermediate files of the document files to a printing unit, and printing and outputting the document files.

Furthermore, a computer-readable recording medium storing a direct printing program in the present invention, comprising and making a direct printing machine execute the processes of: acquiring, with regard to plural document files, information regarding document file names and the number of document files as output control data upon receiving an instruction to print the plural document files from a user, and storing the acquired output control data in an output control data storage unit; sequentially selecting document file names to acquire document formats thereof with reference to the output control data stored in the output control data storage unit; storing, in an output format storage unit, an output format for printing intermediate files outputted by document file expansion programs for expanding the document files, the output format being set by the user; activating document file expansion programs corresponding to the acquired document formats with reference to an activation program table describing activation programs for activating the document file expansion programs capable of expanding the document files depending on the document formats of the document files, the activation program table being stored by an output method storage unit, and acquiring and storing printing intermediate files of document files corresponding to document file names outputted from the activated document file expansion programs; editing the stored printing intermediate files of the document files in accordance with the output format which is stored in the output format storage unit; and transmitting the edited printing intermediate files of the document files to a printing unit, and printing and outputting the document files.

Specifically, the direct printing machine, the direct printing method and the computer-readable recording medium storing a direct printing program in the present invention sequentially activate the document file expansion programs corresponding to the document formats of the document files corresponding to the document file names designated by the user, acquire the printing intermediate files expanded and outputted form the document files corresponding to the document file names by means of the activated document file expansion programs, and edit the acquired printing intermediate files in accordance with the output format set by the user. Moreover, with the configuration as described above, the acquired printing intermediate files are edited in accordance with the output format set by the user, and the plural document files are not expanded in a lump. Accordingly, with a saved resource and in a short time, the plural document files can be subjected to the layout and printed and outputted in accordance with the output format thus designated.

### BRIEF DESCRIPTION OF THE DRAWINGS

FIG. 1 is a block diagram showing a configuration example of a direct printing machine serving as an embodiment of the present invention.

FIG. 2 is a view showing an activation program table stored in advance in an output method storage unit shown in FIG. 1.

FIG. 3 is a flowchart showing an operation procedure of the direct printing machine shown in FIG. 1.

FIG. 4 is a flowchart showing a subroutine of output format setting processing shown in FIG. 3.

FIG. 5 is a view showing a configuration of an output format setting screen serving as an embodiment of the present invention.

FIG. 6 is a flowchart showing a subroutine of printing intermediate file creation processing shown in FIG. 3.

FIGS. 7A and 7B are views showing examples of printing intermediate files.

FIG. 8 is a flowchart showing a subroutine of editing processing shown in FIG. 3.

FIGS. 9A and 9B are views showing editing examples of the printing intermediate files shown in FIGS. 7A and 7B.

FIG. 10 is a view showing a printing intermediate file created by editing processing shown in FIGS. 9A and 9B.

FIG. 11 is a view showing documents printed and outputted by the printing intermediate files shown in FIGS. 7A and 7B.

FIG. 12 is a view showing documents printed and outputted by the printing intermediate file shown in FIG. 10.

FIG. 13 is a flowchart showing a subroutine of output processing shown in FIG. 3.

FIG. 14 is an appearance diagram of a computer system in the embodiment of the invention.

### DETAILED DESCRIPTION OF THE PREFERRED EMBODIMENTS

A configuration and operation of a direct printing machine serving as an embodiment of the present invention will be described below in detail with reference to the drawings.

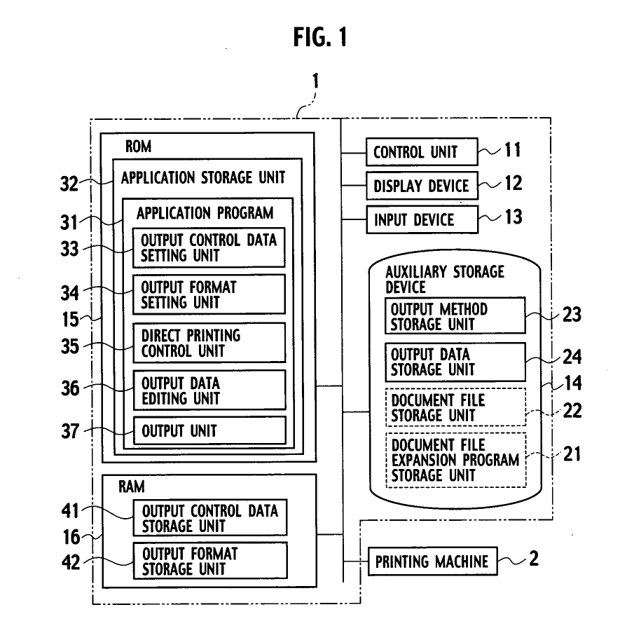

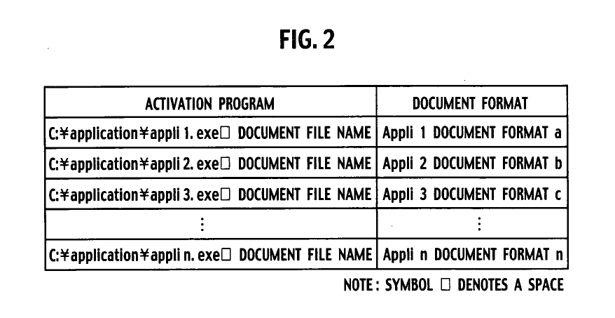

First, the direct printing machine serving as the embodiment of the present invention will be described with reference to FIGS. 1 and 2.

As shown in FIG. 1, the direct printing machine serving as the embodiment of the present invention includes, as main constituent elements, an information processing apparatus 1 such as a personal computer, and a printing machine 2 such as a laser beam printer and an inkjet printer. The information processing apparatus 1 is configured to be capable of printing and outputting a document file by using the printing machine 2. Note that, in this specification, the “document file” is referred to as document data described in an arbitrary document format.

The information processing apparatus 1 includes a control unit 11 composed of a processor such as a central processing unit (CPU), a display device 12 such as a cathode ray tube (CRT) and a liquid crystal display, an input device 13 such as a keyboard and a mouse pointer, an auxiliary storage device 14 which stores various data and computer programs, a read only memory (ROM) 15 which stores an application program to be described later, and a random access memory (RAM) 16 which acts as a working area of the control unit 11 in the case of executing direct printing processing to be described later.

The auxiliary storage device 14 includes a document file expansion program storage unit 21 which stores various document file expansion programs, each of which is capable of creating and expanding the document file, a document file storage unit 22 which stores the document files according to various document formats such as those of Word (registered trademark), Excel (registered trademark) and Ichitaro (registered trademark), which are created by the document file expansion programs, an output method storage unit 23 which stores an activation program table as shown in FIG. 2, in which activation programs for activating the document file expansion programs are described depending on the document formats. For example, the activation program table may be that as shown in FIG. 2, in which each of the activation programs is described for each of the document formats, or in the table, activation programs are described for each of the document formats. The auxiliary storage device 14 includes an output data storage unit 24 which stores printing intermediate files (to be described later in detail) which are outputted by the document file expansion programs in the case of the direct printing processing to be described later. Note that it is premised that the activation program table is created in advance and is stored in the output method storage unit 23.

The ROM 15 includes an application storage unit 32 which stores an application program 31 capable of expanding and printing a document file of an arbitrary document format. In this embodiment, the application program 31 includes an output control data setting unit 33 which acquires, as output control data, information regarding document file names, the number of document files and a printing order of the document files with regard to document files designated to be printed by a user from among the document files stored in the document file storage unit 22, an output format setting unit 34 by which the user sets an output format of the printing intermediate files, a direct printing control unit 35 which performs various controls for printing and outputting plural document files different in document format, an output data editing unit 36 which edits the printing intermediate files, which are stored in the output data storage unit 24, according to an output format stored in an output format storage unit 42, and an output unit 37 which converts the printing intermediate files edited by the output data editing unit 36, into a printing intermediate file of a data format supported by the printing machine 2, and then transmits the printing intermediate file concerned to the printing machine 2. Note that the application program 31 acts as a direct printing program according to this embodiment of present invention, and the respective constituent elements of the application program 31 are realized by reading the application program 31 from the ROM 15 to the RAM 16 and by executing a sequence program which defines an operation procedure of the respective constituent elements.

The RAM 16 includes an output control data storage unit 41 which stores the output control data acquired by the output control data setting unit 33, and the output format storage unit 42 which stores information regarding the output format for the printing intermediate files, which is set by the user in the output format setting unit 34.

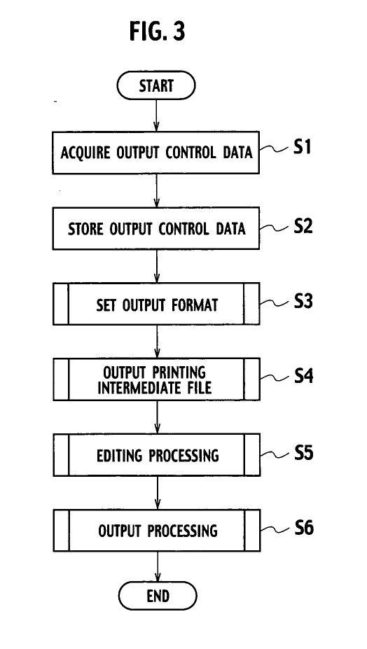

The direct printing machine configured as described above executes operations to be described below. Thus, when batch printing (hereinafter, referred to as direct printing processing) of the plural document files different in document format, which are stored in the document file storage unit 22, is instructed, the direct printing machine makes layout for the plural document files and prints and outputs the document files concerned according to the information regarding the designated output format with a saved resource and in a short time. The operations of the direct printing machine in the case of executing the direct printing processing will be described below with reference to a flowchart shown in FIG. 3.

The flowchart shown in FIG. 3 shows a procedure of the operations of the direct printing machine of this embodiment of the present invention. The operations are started in a manner that the user selects the plural document files to be printed in a desired printing order from the document files stored in the document file storage unit 22, and then operates the input device 13 to instruct the execution of the direct printing processing.

In the processing of Step S1, the output control data setting unit 33 acquires the information regarding the names, number and selection order (printing order) of the document files selected by the user, and passes the acquired information to the output control data storage unit 41.

In the processing of Step S2, the output control data storage unit 41 stores, as the output control data, the information regarding the names, number and printing order of the document files, which is passed from the output control data setting unit 33.

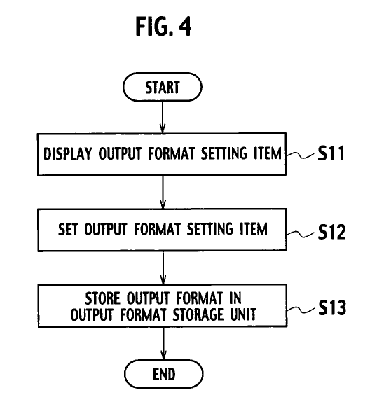

In the processing of Step S3, the output format setting unit 34 displays an output format setting screen on the display device 12, and stores, in the output format storage unit 42, the information regarding the output format for the printing intermediate files, which is set by the operation of the user for the input device 13 with reference to the output format setting screen, (output format setting processing). Note that details of the output format setting processing will be described later with reference to a flowchart shown in FIG. 4.

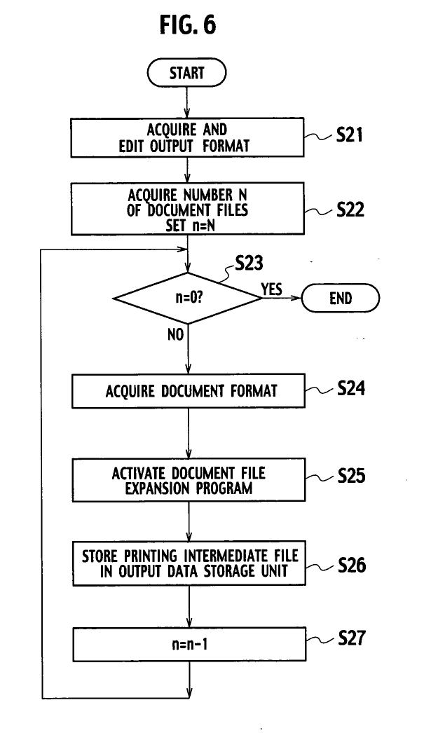

In the processing of Step S4, the direct printing control unit 35 activates an activation program for activating document file expansion programs corresponding to the document formats of the document files, which correspond to the document file names selected by the user, with reference to the activation program table stored in the output method storage unit 23. Note that the document file expansion programs activated by the activation program expand document files corresponding to the document file names selected by the user though the above-described operation. Then, the direct printing control unit 35 stores the printing intermediate files outputted from the document file expansion program in the output data storage unit 24 in accordance with the information regarding the printing order designated by the user (printing intermediate file creation processing). Note that details of the printing intermediate file creation processing will be described later with reference to a flowchart shown in FIG. 6.

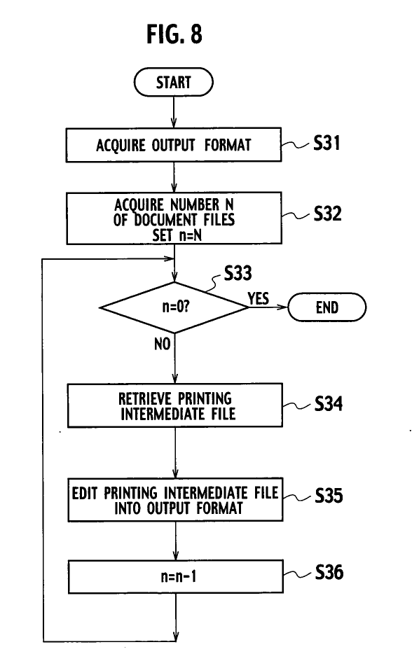

In the processing of Step S5, the output data editing unit 36 edits the printing intermediate files stored in the output data storage unit 24 in accordance with the output format set in the processing of Step S3 (editing processing). Note that details of the editing processing will be described later with reference to a flowchart shown in FIG. 8.

In the processing of Step S6, the output unit 37 converts the printing intermediate files into a data format supported by the printing machine 2, and transmits the converted output data to the printing machine 2 (output processing). Then, the printing machine 2 prints and outputs the plural document files in accordance with the output data transmitted from the output unit 37. Thus, a series of the direct printing processing is completed, and the plural document files of the arbitrary document formats, which are selected by the user, are subjected to the layout and printed and outputted in accordance with the output format designated by the user. Note that details of the output processing will be described later with reference to a flowchart shown in FIG. 13.

Next, the output format setting processing of Step S3 will be described in detail with reference to the flowchart shown in FIG. 4.

The flowchart shown in FIG. 4 shows an operation procedure of the direct printing machine in the output format setting processing, and the operations are started in response to the completion of the processing of step S2.

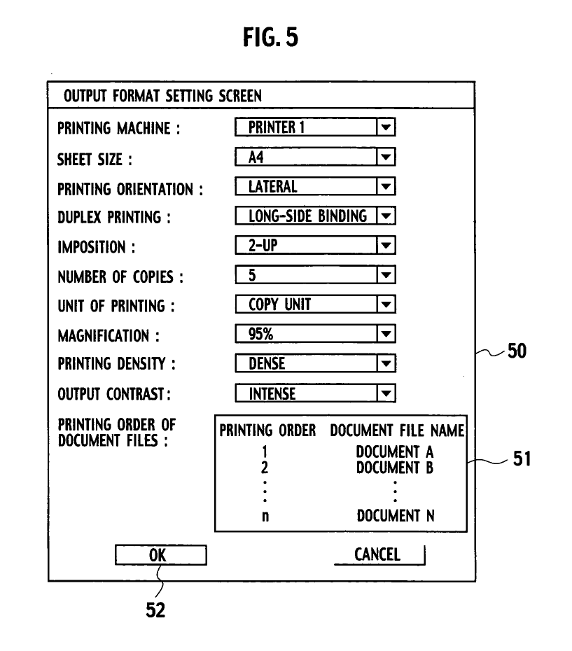

In the processing of Step S11, the output format setting unit 34 displays such an output format setting screen 50 as shown in FIG. 5 on the display device 12, thereby displaying output format setting items. Note that the output format setting screen 50 shown in FIG. 5 is configured so as to be capable of setting the following items as output format of the printing intermediate files by means of a pull-down menu system. The items are: a printing machine for use in printing the document files; a sheet size; a printing orientation; duplex printing including long-side binding, short-side binding, and the like; an imposition including number-up, a signature, a booklet, a continuous mode, and the like; the number of copies; a unit of printing, including a page unit, a copy unit, and the like; a magnification; a printing density; an output contrast; and the like. On a lower portion of the screen, a document file printing order window 51 for displaying the selection order (printing order) of the document files selected by the user is provided. Note that the above-described imposition processing means a layout method of the document files for one print sheet. For example, the “number-up” processing means processing for making layout for N pieces of document files on one print sheet, and printing the document files.

In the processing of Step S12, the user sets the respective items of the output format, which are displayed on the output format setting screen 50, and clicks an OK button 52 of the output format setting screen 50 in response to the completion of the setting. Then, in response to that the OK button 52 is clicked, the output format setting unit 34 advances the output format setting processing to the processing of Step S13.

In the processing of Step S13, the output format setting unit 34 stores, in the output format storage unit 42, information regarding the output format set by the user in the processing of step S12. Thus, a series of the output format setting processing is completed.

Next, the printing intermediate file creation processing of Step S4 will be described in detail with reference to the flowchart shown in FIG. 6.

The flowchart shown in FIG. 6 shows an operation procedure of the direct printing machine in the printing intermediate file creation processing, and the operations are started in response to the completion of the processing of step S3.

In the processing of Step S21, the direct printing control unit 35 reads the information regarding the output format for the printing intermediate files, which is stored in the output format storage unit 42. Note that, in the case of this processing, for the purpose of performing processing to be described later for each of the document files, the direct printing control unit 35 reads the information regarding the output format from the printing intermediate files with regard to the sheet size, the printing orientation, the magnification, the printing density, the output contrast, and the like, and makes default values (reference values) replace values of the imposition, the number of copies, the unit of printing, and the like.

In the processing of Step S22, the direct printing control unit 35 acquires information regarding the number N of document files, which is stored in the output control data storage unit 41, and sets the acquired number N of document files as a value n of a program counter for use in the subsequent processing (n=N).

In the processing of Step S23, the direct printing control unit 35 determines whether the value n of the program counter is 0, thereby determining whether or not an unprocessed document file exists. Then, when the value n of the program counter is 0 as a result of the determination, the direct printing control unit 35 determines that the unprocessed document file does not exist, and completes a series of the printing intermediate file creation processing. Meanwhile, when the value n of the program counter is not 0, the direct printing control unit 35 determines that the unprocessed document file exists, and advances the printing intermediate file creation processing to the processing of Step S24.

In the processing of Step S24, the direct printing control unit 35 reads the document file names in accordance with the information regarding the printing order, which is stored in the output control data storage unit 41, and acquires information regarding the document formats corresponding to the document file names.

In the processing of Step S25, the direct printing control unit 35 activates the activation programs for activating the document file expansion programs corresponding to the document formats of the document files with reference to the activation program table stored in the output method storage unit 23. The document file expansion programs activated by the activation programs read and expand document files corresponding to the read document file names from the document file storage unit 22. Subsequently, the direct printing control unit 35 acquires printing intermediate files of the document files corresponding to the read document file names, which are outputted by the document file expansion programs.

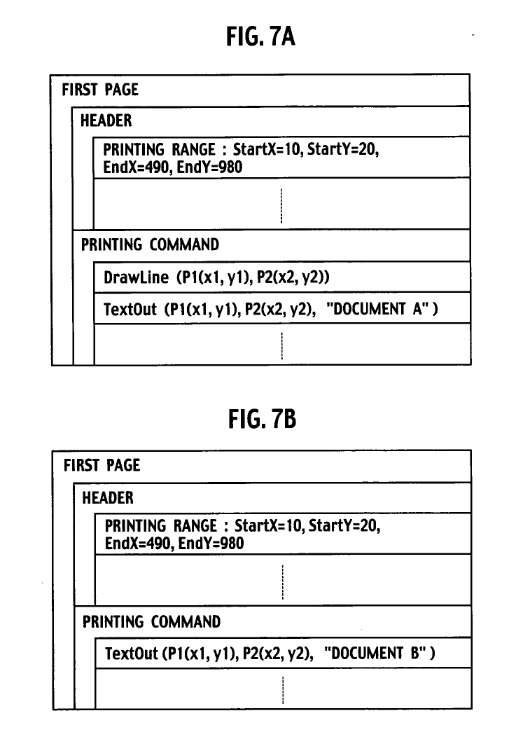

Note that the printing intermediate files outputted by the document file expansion programs have configurations, for example, as shown in FIGS. 7A and 7B. In the printing intermediate files, commands common to various printing machines, which designate an output mode of document data, such as coordinates of a printing range, are described by formats independent of a command format intrinsic to each printing machine. Specifically, in the printing intermediate file shown in FIG. 7A, described are information to the effect that printing starting coordinates and printing ending coordinates of a document A are (10, 20) and (490, 980), respectively, and a printing command to the effect that data of the document A is to be printed on a range of the above-described coordinates. Moreover, in the printing intermediate file shown in FIG. 7B, described are information to the effect that printing starting coordinates and printing ending coordinates of a document B are (10, 20) and (490, 980), respectively, and a printing command to the effect that data of the document B is to be printed on a range of the above-described coordinates.

In the processing of Step S26, the direct printing control unit 35 stores the printing intermediate files, which are outputted by the document file expansion programs, in the output data storage unit 24 in accordance with the information regarding the printing order.

In the processing of Step S27, the direct printing control unit 35 subtracts 1 from the value n of the program counter, thereby making a setting to the effect that the processing is completed for one document file name stored in the output control data storage unit 41. Subsequently, the direct printing control unit 35 returns this output processing to the processing of Step S23.

Next, the editing processing of Step S5 will be described in detail with reference to the flowchart shown in FIG. 8.

The flowchart shown in FIG. 8 shows an operation procedure of the direct printing machine in the editing processing, and the operations are started in response to the completion of the processing of step S4.

In the processing of Step S31, the output data editing unit 36 acquires the information regarding the output format for the printing intermediate files, which is stored in the output format storage unit 42.

In the processing of Step S32, the output data editing unit 36 acquires the number N of document files, which is stored in the output control data storage unit 41, and sets the acquired number N of document files as the value n of the program counter for use in the subsequent processing (n=N).

In the processing of Step S33, the output data editing unit 36 determines whether the value n of the program counter is 0, thereby determining whether or not the unprocessed document file exists. Then, when the value n of the program counter is 0 as a result of the determination, the output data editing unit 36 determines that the unprocessed document file does not exist, and completes a series of the editing processing. Meanwhile, when the value n of the program counter is not 0, the output data editing unit 36 determines that the unprocessed document file exists, and advances the editing processing to the processing of Step S34.

In the processing of Step S34, the output data editing unit 36 reads the printing intermediate files from the output data storage unit 24 in accordance with the information regarding the printing order, which is stored in the output control data storage unit 41.

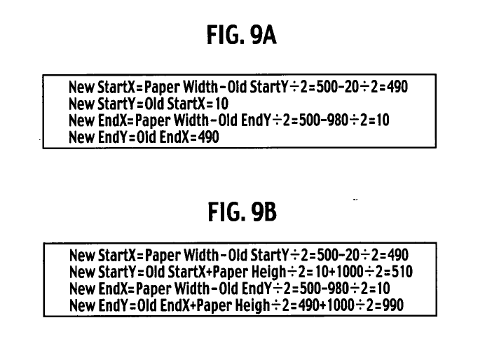

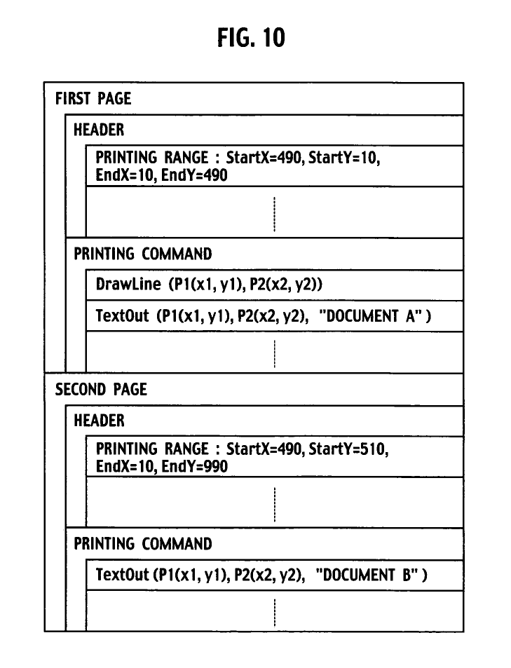

In the processing of Step S35, the output data editing unit 36 edits the printing intermediate files read by the processing of Step S35 into the output format set by the user with reference to the information regarding the output format for the printing intermediate files, which is acquired by the processing of Step S31. Specifically, for example, when the user designates, as the imposition processing, 2-up processing for making layout for two document files onto one print sheet, and the printing intermediate files of two document files have the configurations as shown in FIGS. 7A and 7B, the output data editing unit 36 performs the following operations with reference to width and height (for example, paper width=500, paper height=1000) in a sheet size set by the user. First, as shown in FIGS. 9A and 9B, the output data editing unit 36 edits commands showing printing coordinate positions of the two document files such that the respective document files remain within the print sheet (coordinate conversion), and then, creates a printing intermediate file as shown in FIG. 10.

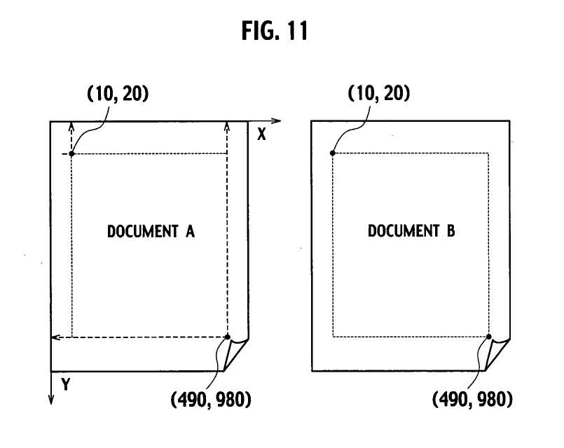

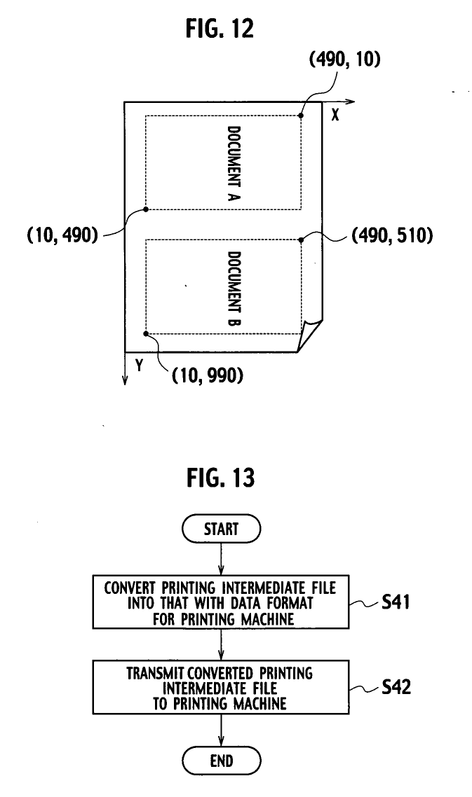

Note that, in this example, the printing starting coordinates and printing ending coordinates of the document A are individually edited from (Old Start X(10), Old Start Y(20)) and (Old End X(490), Old End Y(980)) to (New Start X(490), New Start Y(10)) and (New End X(10), New End Y(490)). Moreover, the printing starting coordinates and printing ending coordinates of the document B are individually edited from (Old Start X(10), Old Start Y(20)) and (Old End X(490), Old End Y(980)) to (New Start X(490), New Start Y(510)) and (New End X(10), New End Y(990)). Then, according to the processing as described above, while the document A and the document B are printed and outputted to the print sheet independently of each other as shown in FIG. 11 when the printing intermediate files are transmitted to the printing machine 2 without being edited, the two document files A and B different in document format are subjected to the layout and printed and outputted in accordance with the output format designated by the user when the printing intermediate file is created in accordance with the 2-up setting.

In the processing of Step S36, the output data editing unit 36 subtracts 1 from the value n of the program counter, thereby making a setting to the effect that the processing is completed for one printing intermediate file stored in the output data storage unit 24. Subsequently, the output data editing unit 36 returns this editing processing to the processing of Step S33.

Finally, the output processing of Step S6 will be described in detail with reference to the flowchart shown in FIG. 13.

The flowchart shown in FIG. 13 shows an operation procedure of the direct printing machine in the output processing, and the operations are started in response to the completion of the processing of step S5.

In the processing of Step S41, the output unit 37 converts the printing intermediate file stored in the output data storage unit 24 into a printing intermediate file with the data format supported by the printing machine 2. (This processing is normal processing of a printer driver.)

In the processing of Step S42, the output unit 37 transmits, to the printing machine 2, the printing intermediate file converted into that of the data format supported by the printing machine 2. Then, the printing machine 2 prints and outputs the document file in accordance with the printing intermediate file which is transmitted from the output unit 37 and converted into the data format supported by the printing machine 2. Thus, a series of the output processing is completed.

As apparent from the above description, in the direct printing machine serving as the embodiment of the present invention, the direct printing control unit 35 acquires the document formats of the document file names read in accordance with the information regarding the printing order, which is stored in the output control data storage unit 41, and activates the document file expansion programs corresponding to the acquired document formats with reference to the activation program table stored in advance in the output method storage unit 23. The direct printing control unit 35 acquires the printing intermediate files of the document files corresponding to the document file names, which are outputted from the activated document file expansion programs, and stores the acquired printing intermediate files in the output data storage unit 24. The output data editing unit 36 edits the acquired printing intermediate files in accordance with the output format set by the user with reference to the output format storage unit 42. Then, with the configuration described above, the acquired printing intermediate files are edited in accordance with the output format set by the user, and the plural document files are not expanded in a lump. Accordingly, with a saved resource and in a short time, the plural document files can be subjected to the layout and printed and outputted in accordance with the output format thus designated.

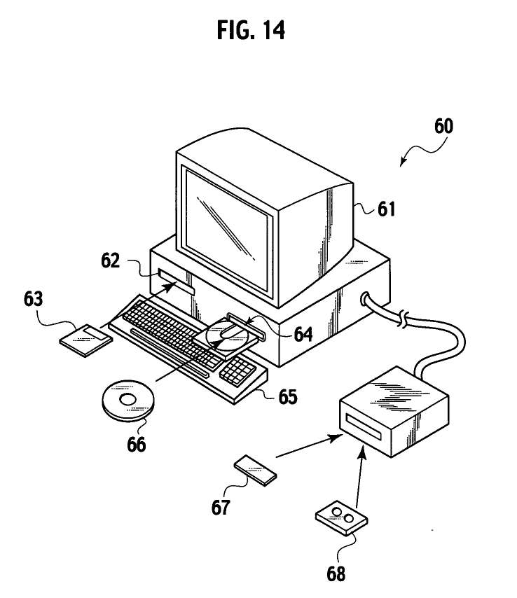

Although the invention has been described above by reference to certain embodiments of the invention, the invention is not limited to the embodiments described above. For example, the application program 31 may be stored in a computer-readable recording medium. When executing the direct printing process, this recording medium is read into computer system, and the program is stored in the memory unit or the like, and by executing the application program 31 by the CPU or other operating unit, the direct printing process of embodiment of the invention is realized. Herein, the recording medium includes, for example, a hard disk, a flexible disk, a compact disk, an IC chip, a cassette tape, and other computer-readable medium in which programs can be recorded. Storage, transport, or sale of the program is easily conducted by use of such a recoding medium recording the program. The computer system used in this case has an appearance, for example, as shown in FIG. 14. That is, it comprises a floppy disk drive 62 and an optical disk drive 65, and a floppy disk 63 is inserted into the floppy disk drive 62, an optical disk 66 is inserted into the optical disk drive 65, and by the specified reading operation, the programs stored in these media can be installed in the system. Or, by connecting a specified drive device, for example, by using a ROM 67 playing the role of a memory device or a cartridge 68 playing the role of a magnetic tape device, installing or data reading can be executed. Further, the user can recognize the output information relating to the printing process by the output through a display 61, and also enter input information relating to the printing process through a keyboard 64. Although not shown herein, a mouse pointer may be used also as an input device. The program may be transmitted to the computer system via network such as Internet, and be installed in the system. In this manner, Modifications and variations of the embodiments described above will occur to those skilled in the art, in light of the teachings. The scope of the invention is defined with reference to the following claims.

The entire content of a Patent Application No. TOKUGAN 2004-67596 with a filing date of Mar. 10, 2004, is hereby incorporated by reference.

1. A direct printing machine, comprising:
an output control data setting unit which acquires, with regard to plural document files, information regarding document file names and the number of document files as output control data upon receiving an instruction to print the plural document files;
an output control data storage unit which stores the output control data acquired by the output control data setting unit;
an output method storage unit which stores an activation program table describing activation programs for activating document file expansion programs capable of expanding the document files depending on document formats of the document files;
an output format setting unit which sets an output format for printing intermediate files outputted by the document file expansion programs activated by the activation programs;
an output format storage unit which stores the output format which is set by the output format setting unit;
a direct printing control unit which sequentially selects document file names to acquire document formats thereof with reference to the output control data stored by the output control data storage unit, activates document file expansion programs corresponding to the acquired document formats with reference to the activation program table stored in the output method storage unit, and acquires printing intermediate files of document files corresponding to document file names outputted from the activated document file expansion programs;
an output data storage unit which stores the printing intermediate files of the document files, the printing intermediate files being acquired by the direct printing control unit;
an output data editing unit which edits the printing intermediate files of the document files, the printing intermediate files being stored in the output data storage unit, in accordance with the output format for the printing intermediate files, the output format being stored in the output format storage unit;
an output unit which transmits, to a printing unit, the printing intermediate files of the document files, the printing intermediate files being edited by the output data editing unit; and
the printing unit which prints and outputs the document files in accordance with the printing intermediate files edited by the output data editing unit and transmitted from the output unit.

2. The direct printing machine according to claim 1,
wherein the output control data setting unit stores information regarding a printing order of the plural document files, and the direct output control unit, the output data editing unit and the output unit execute the processing thereof in accordance with the information regarding the printing order of the document files.

3. A direct printing method, comprising the steps of:
acquiring and storing, with regard to plural document files, information regarding document file names and the number of document files as output control data upon receiving an instruction to print the plural document files from a user;
sequentially selecting document file names to acquire document formats thereof with reference to the output control data;
storing an output format for printing intermediate files outputted by document file expansion programs for expanding the document files, the output format being set by the user;
activating document file expansion programs corresponding to the acquired document formats with reference to an activation program table describing activation programs for activating the document file expansion programs capable of expanding the document files depending on the document formats of the document files, and acquiring and storing printing intermediate files of document files corresponding to document file names outputted from the activated document file expansion programs;
editing the stored printing intermediate files of the document files in accordance with the output format which is set by the user; and
transmitting the edited printing intermediate files of the document files to a printing unit, and printing and outputting the document files.

4. The direct printing method according to claim 3, further comprising the step of:
storing information regarding a printing order of the plural document files,
wherein the respective processing steps are executed in accordance with the information regarding the printing order of the document files.

5. A computer-readable recording medium storing a direct printing program, comprising and making a direct printing machine execute the processes of:
acquiring, with regard to plural document files, information regarding document file names and the number of document files as output control data upon receiving an instruction to print the plural document files from a user, and storing the acquired output control data in an output control data storage unit;
sequentially selecting document file names to acquire document formats thereof with reference to the output control data stored in the output control data storage unit;
storing, in an output format storage unit, an output format for printing intermediate files outputted by document file expansion programs for expanding the document files, the output format being set by the user;
activating document file expansion programs corresponding to the acquired document formats with reference to an activation program table describing activation programs for activating the document file expansion programs capable of expanding the document files depending on the document formats of the document files, the activation program table being stored by an output method storage unit, and acquiring and storing printing intermediate files of document files corresponding to document file names outputted from the activated document file expansion programs;
editing the stored printing intermediate files of the document files in accordance with the output format which is stored in the output format storage unit; and
transmitting the edited printing intermediate files of the document files to a printing unit, and printing and outputting the document files.

6. The computer-readable recording medium storing a direct printing program according to claim 5, further comprising and making a direct printing machine execute the process of:
storing information regarding an printing order of the plural document files in the output control data storage unit,
wherein the direct printing machine executes each of the processing steps in accordance with the information regarding the printing order of the document files.
